(19) United States
(12) Patent Application Publication
(10) Pub. No.: US 2007/0031705 A1
(43) Pub. Date: Feb. 8, 2007

(54) Magnetic recording medium and process for producing the same

(75) Inventors: Kazuhiro Hattori, Tokyo (JP); Mitsuru Takai, Tokyo (JP)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 10/571,481

(22) PCT Filed: Sep. 24, 2004
(86) PCT No.: PCT/JP04/13968

§ 371 Date: Mar. 14, 2006

(30) Foreign Application Priority Data
Sep. 26, 2003 (JP) 2003-335061

(51) Int. Cl. G11B 5/66; B05D 5/12

(52) U.S. Cl. 428/827; 428/831.2; 427/127

(57) ABSTRACT

A low cost magnetic recording medium having low surface roughness and a method for manufacturing the magnetic recording medium are provided. A soft magnetic layer 16 has a laminate structure including a first soft magnetic layer 26 on the substrate 12 side and a second soft magnetic layer 28 on the recording layer 20 side. The second soft magnetic layer 28 is formed such that the surface roughness of the surface 28A on the recording layer 20 side of the second soft magnetic layer 28 is less than the surface roughness of the base surface 12A of the substrate 12 and is less than the surface roughness of the surface 26A on the recording layer 20 side of the first soft magnetic layer 26.

### TECHNICAL FIELD

The present invention relates to a magnetic recording medium such as, for example, a hard disk and to a method for manufacturing the same.

### BACKGROUND ART

In a magnetic recording medium, it is important to lower surface roughness as much as possible for improving recording/reproducing accuracy. For example, in the case of a hard disk, a flying type head has mainly been employed. In order to achieve favorable recording/reproducing accuracy, reducing surface roughness as much as possible is important for maintaining the gap between the flying type head and the magnetic recording medium within a very small range.

Conventionally, in the manufacturing steps of a magnetic recording medium such as a hard disk, a base surface on either one or both sides of a substrate is polished and flattened by means of a CMP (Chemical Mechanical Polishing) method or a similar method. A recording layer, a protective layer, and other layers are then laminated over the base surface of the substrate by means of a sputtering method or other methods to thereby lower the overall surface roughness of the magnetic recording medium as much as possible (see, for example, Japanese Patent Laid-Open Publication No. Hei 5-314471 and Japanese Patent Laid-Open Publication No. Hei 9-231562).

### DISCLOSURE OF INVENTION

However, when flattening a substrate in a conventional manner, the base surface of a substrate is required to be repeatedly polished a plurality of times in order to finish with the desired surface roughness, resulting in low production efficiency.

In particular, when a CMP method is employed, the base surface of a substrate must be washed to remove slurry for each time after polishing repeatedly carried out a plurality of times. This has been the cause for significantly deteriorating the production efficiency.

In addition, since a conventional substrate is manufactured with low production efficiency, the cost of the substrate has accounted for a large proportion of the cost of a magnetic recording medium.

Also, even if the base surface of a substrate is finished flat, the surface roughness gradually increases during the process of laminating a seed layer, a soft magnetic layer, and other layers. Thus, the final overall surface roughness of the magnetic recording medium occasionally exceeds a permissible range.

For example, in order to improve areal density, a hard disk of a perpendicular recording type has been increasingly employed in recent years. In such a perpendicular recording type hard disk, a soft magnetic layer thicker than a recording layer is provided between a substrate and the recording layer, and thus the overall surface roughness of the magnetic recording medium tends to increase.

In addition, as a candidate for a magnetic recording medium which can implement the continued improvement of the areal density, attention is directed to a magnetic recording medium of, for example, a discrete type in which a recording layer is formed in a concavo-convex pattern. However, the recording layer formed in the concavo-convex pattern tends to have a still larger surface roughness.

The surface roughness of the magnetic recording medium having a recording layer formed in a concavo-convex pattern can be lowered by polishing the surface of the recording layer by means of a CMP method or a similar method. However, polishing a thin recording layer is practically difficult to control, and the recording layer may be degraded through the chemical action of a liquid formulation or the like to cause the deterioration of the magnetic characteristics. In addition, when such a polishing step is employed, the production efficiency is reduced.

Further, the flying height of a magnetic head tends to be lowered as the areal density is improved. As the flying height is lowered, the recording/reproducing accuracy of a magnetic recording medium is occasionally lowered greatly even when the surface roughness is in a range in which problems have not conventionally arisen.

The present invention has been made in view of the above problems, and various exemplary embodiments of the present invention provide a low cost magnetic recording medium having a low surface roughness and a method for manufacturing the magnetic recording medium.

The present invention implements a low cost magnetic recording medium having low surface roughness by providing, between a substrate and a recording layer, an intermediate layer having a surface roughness on the recording layer side less than that of the base surface of the substrate. That is, since the flat intermediate layer is provided at a position which is closer to the surface of the magnetic recording medium than the substrate is, the magnetic recording medium having low surface roughness can be manufactured with high efficiency and at low cost. In addition, since the recording layer is formed into a flat shape following the flat intermediate layer, processing for flattening the surface of the recording layer is not required. Further, even if the processing is required, the deterioration of the recording layer can be prevented since the amount of processing can be restrained.

In the case of a perpendicular recording type magnetic recording medium comprising a soft magnetic layer, a configuration in which the soft magnetic layer also serves as the intermediate layer is advantageous. The soft magnetic layer is significantly thicker than the recording layer. Therefore, even when the surface of the soft magnetic layer is processed for flattening, the effects on the magnetic properties are suppressed to be small.

Moreover, since a dry process for flattening such as ion beam etching, reactive ion etching, or reactive ion beam etching is employed instead of a wet process such as a CMP method, the deterioration of the characteristics of the intermediate layer such as the soft magnetic layer can be further suppressed.

Further, in the present invention, the soft magnetic layer serving as the intermediate layer has a configuration comprising a first soft magnetic layer and a second soft magnetic layer formed on the first soft magnetic layer. By lowering the surface roughness of the second soft magnetic layer to less than that on the recording layer side surface of the first soft magnetic layer and also to less than that of the base surface of the substrate, a low cost magnetic recording medium having low surface roughness is implemented.

For example, since the first soft magnetic layer on the base surface of the substrate is formed by means of a sputtering method or a plating method, the soft magnetic layer significantly thicker than the other layers can be efficiently formed. Further, since the second soft magnetic layer is formed on the first soft magnetic layer by means of a deposition technique such as a bias sputtering method applying bias power, the deposition of the second soft magnetic layer proceeds while a convex portion on the second soft magnetic layer is selectively etched. Therefore, the second soft magnetic layer having low surface roughness can be formed. Since the recording layer and other layers are formed over such a second soft magnetic layer having low surface roughness, a magnetic recording medium having low surface roughness can be manufactured with high efficiency and at low cost. Further, since the second soft magnetic layer is flattened by means of ion beam etching or the like, a magnetic recording medium having low surface roughness can be reliably manufactured with high efficiency and at low cost.

Alternatively, in the present invention, a low cost magnetic recording medium having low surface roughness is implemented through forming the intermediate layer by means of a deposition technique applying bias power or through flattening the surface of the intermediate layer by means of dry etching such as ion beam etching, reactive ion etching, or reactive ion beam etching. That is, since a wet process is not employed but the flat intermediate layer is formed by means of a deposition technique applying bias power or the intermediate layer is flattened by means of dry etching, a magnetic recording medium having low surface roughness can be manufactured with high efficiency and at low cost. In addition, since these processing techniques are not employed for forming the recording layer and for processing the recording layer, the deterioration of the recording layer can be suppressed.

The present invention aims to solve the above problems and will be described hereinbelow.
(1) A magnetic recording medium having a soft magnetic layer and a recording layer formed in this order over a base surface of a substrate having at least one surface serving as the base surface, wherein an intermediate layer is provided between the substrate and the recording layer, and a surface roughness of the surface on the recording layer side of the intermediate layer is less than a surface roughness of the base surface of the substrate.
(2) The magnetic recording medium according to (1), wherein the soft magnetic layer serves also as the intermediate layer.
(3) The magnetic recording medium according to (2), wherein: the soft magnetic layer has a laminate structure of a first soft magnetic layer on the side of the substrate and a second soft magnetic layer on the side of the recording layer; and the surface roughness of the surface on the recording layer side of the second soft magnetic layer is less than the surface roughness of the base surface of the substrate and is less than the surface roughness of the surface on the recording layer side of the first soft magnetic layer.
(4) A magnetic recording medium having a recording layer formed over a base surface of a substrate having at least one surface serving as the base surface, wherein an intermediate layer is provided between the substrate and the recording layer so as to be in contact with the recording layer, and a surface roughness of the surface on the recording layer side of the intermediate layer is less than a surface roughness of the base surface of the substrate.
(5) The magnetic recording medium according to any one of (1) to (4), wherein an arithmetical mean deviation of the surface on the recording layer side of the intermediate layer is 1 nm or less.
(6) A method for manufacturing a magnetic recording medium having a soft magnetic layer and a recording layer formed in this order over a base surface of a substrate having at least one surface serving as the base surface, the method comprising: an intermediate layer forming step of forming an intermediate layer over the base surface of the substrate while applying a bias power in a direction of the substrate such that a surface roughness of the intermediate layer is less than a surface roughness of the base surface of the substrate; and a recording layer forming step of forming the recording layer over the intermediate layer.
(7) A method for manufacturing a magnetic recording medium having a soft magnetic layer and a recording layer formed in this order over a base surface of a substrate having at least one surface serving as the base surface, the method comprising: an intermediate layer forming step of forming an intermediate layer over the base surface of the substrate; an intermediate layer flattening step of flattening the surface of the intermediate layer by processing by means of dry etching such that a surface roughness of the intermediate layer is less than a surface roughness of the base surface of the substrate; and a recording layer forming step of forming the recording layer over the intermediate layer.
(8) The method for manufacturing a magnetic recording medium according to (6) or (7), wherein the soft magnetic layer is formed as the intermediate layer in the intermediate layer forming step.
(9) A method for manufacturing a magnetic recording medium having a recording layer formed over a base surface of a substrate having at least one surface serving as the base surface, the method comprising: an intermediate layer forming step of forming an intermediate layer over the base surface of the substrate while applying a bias power in a direction of the substrate such that a surface roughness of the intermediate layer is less than a surface roughness of the base surface of the substrate; and a recording layer forming step of forming the recording layer on the intermediate layer so as to be in contact with the intermediate layer. (10) The method for manufacturing a magnetic recording medium according to (6) or (9), wherein an intermediate layer flattening step of flattening the surface of the intermediate layer by means of dry etching is provided between the intermediate layer forming step and the recording layer forming step.
(11) A method for manufacturing a magnetic recording medium having a recording layer formed over a base surface of a substrate having at least one surface serving as the base surface, the method comprising: an intermediate layer forming step of forming an intermediate layer over the base surface of the substrate; an intermediate layer flattening step of flattening the surface of the intermediate layer by processing by means of dry etching such that a surface roughness thereof is less than a surface roughness of the base surface of the substrate; and a recording layer forming step of forming the recording layer on the intermediate layer so as to be in contact with the intermediate layer.
(12) A method for manufacturing a magnetic recording medium according to any one of (6), (7), (9), and (11), wherein the surface of the intermediate layer is finished such that an arithmetical mean deviation of the surface is 1 nm or less.
(13) A method for manufacturing a magnetic recording medium according to (8), wherein the surface of the intermediate layer is finished such that an arithmetical mean deviation of the surface is 1 nm or less.
(14) A method for manufacturing a magnetic recording medium having a soft magnetic layer and a recording layer formed in this order over a base surface of a substrate having at least one surface serving as the base surface, the method comprising: a first soft magnetic layer forming step of forming a first soft magnetic layer by depositing a soft magnetic material over the base surface of the substrate by means of either a sputtering method or a plating method; a second soft magnetic layer forming step of forming a second soft magnetic layer having a surface roughness less than a surface roughness of the base surface of the substrate by depositing a soft magnetic material on the first soft magnetic layer while a bias power is applied in a direction of the substrate; and a recording layer forming step of forming the recording layer over the second soft magnetic layer.
(15) A method for manufacturing a magnetic recording medium having a soft magnetic layer and a recording layer formed in this order over a base surface of a substrate having at least one surface serving as the base surface, the method comprising: a first soft magnetic layer forming step of forming a first soft magnetic layer by depositing a soft magnetic material over the base surface of the substrate by means of either a sputtering method or a plating method; a second soft magnetic layer forming step of forming a second soft magnetic layer by depositing a soft magnetic material on the first soft magnetic layer while a bias power is applied in a direction of the substrate; a soft magnetic layer flattening step of flattening the surface of the second soft magnetic layer such that a surface roughness is less than a surface roughness of the base surface of the substrate by processing the surface of the second soft magnetic layer by means of dry etching; and a recording layer forming step of forming the recording layer over the second soft magnetic layer.
(16) The method for manufacturing a magnetic recording medium according to (14) or (15), wherein the surface of the second soft magnetic layer is finished such that an arithmetical mean deviation of the surface is 1 nm or less.

In the present application, the term “ion beam etching” shall be used as a generic term for a method for removing processing, for example, ion milling, in which an object to be processed is exposed to ionized gas, and is not limited to a processing method in which an ion beam is focused for irradiation.

Moreover, in the present application, the term “a magnetic recording medium” shall refer not only to a hard disk, a floppy (registered trademark) disk, a magnetic tape, and the like, which utilize only magnetism for recording and reproducing information, but also to a magneto-optical recording medium, such as an MO (Magneto Optical), which utilizes magnetism in combination with light, and to a recording medium of a heat-assisted type which utilizes magnetism in combination with heat.

### BRIEF DESCRIPTION OF THE DRAWINGS

FIG. 1 is a cross-sectional side view schematically showing the structure of a magnetic recording medium according to a first exemplary embodiment of the present invention.

FIG. 2 is a flowchart illustrating an overview of the manufacturing steps of the above magnetic recording medium.

FIG. 3 is a cross-sectional side view schematically showing the shape of a substrate of the above magnetic recording medium after press molding.

FIG. 4 is a cross-sectional side view schematically showing a state in which an underlayer is formed on the above substrate.

FIG. 5 is a cross-sectional side view schematically showing a state in which a first soft magnetic layer is formed on the above underlayer.

FIG. 6 is a cross-sectional side view schematically showing a state in which a second soft magnetic layer is formed on the above first soft magnetic layer.

FIG. 7 is a cross-sectional side view schematically showing a state in which a seed layer is formed on the above second soft magnetic layer.

FIG. 8 is a cross-sectional side view schematically showing a state in which a recording layer is formed on the above seed layer.

FIG. 9 is a flowchart illustrating an overview of the manufacturing steps of the magnetic recording medium according to the first exemplary embodiment of the present invention.

FIG. 10 is a cross-sectional side view schematically showing the structure of the above magnetic recording medium.

FIG. 11 is a cross-sectional side view schematically showing a state in which the second soft magnetic layer is flattened in the manufacturing process of the above magnetic recording medium.

FIG. 12 is a cross-sectional side view schematically showing the structure of a magnetic recording medium according to a third exemplary embodiment of the present invention.

FIG. 13 is a flowchart illustrating an overview of the manufacturing steps of the above magnetic recording medium.

FIG. 14 is a cross-sectional side view schematically showing a state in which a soft magnetic layer is flattened in the manufacturing process of the above magnetic recording medium.

FIG. 15 is a cross-sectional side view schematically showing the structure of a magnetic recording medium according to a fourth exemplary embodiment of the present invention.

FIG. 16 is an enlarged AFM picture showing the surface state of the base surface of the substrate of a magnetic recording medium according to Example 1 of the present invention.

FIG. 17 is an enlarged AFM picture showing the surface state of the first soft magnetic layer of the above magnetic recording medium.

FIG. 18 is an enlarged AFM picture showing the surface state of the second soft magnetic layer of the magnetic recording medium according to a Working Example 1 of the present invention.

FIG. 19 is an enlarged AFM picture showing the surface state of the first soft magnetic layer of a magnetic recording medium according to a Working Example 3 of the present invention.

FIG. 20 is an enlarged AFM picture showing the surface state of the second soft magnetic layer of a magnetic recording medium according to a Working Example 6 of the present invention.

FIG. 21 is a flowchart illustrating an overview of another example of the manufacturing steps of a magnetic recording medium according to the third exemplary embodiment of the present invention.

### BEST MODE FOR CARRYING OUT THE INVENTION

Preferred exemplary embodiments of the present invention will be described hereinbelow in detail with reference to the drawings.

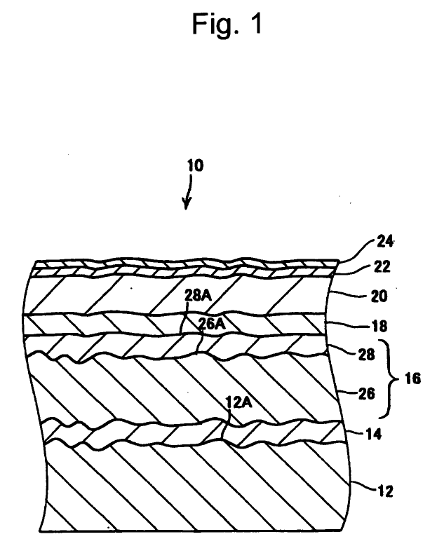

As shown in FIG. 1, a magnetic recording medium 10 according to the present exemplary embodiment is a perpendicular recording type comprising a substrate 12 having one surface serving as a base surface 12A, and an underlayer 14, a soft magnetic layer (an intermediate layer) 16, a seed layer 18, a recording layer 20, a protective layer 22, and a lubricating layer 24 are formed in this order over the base surface 12A.

The magnetic recording medium 10 is characterized in that the soft magnetic layer 16 is a laminate formed of a first soft magnetic layer 26 on the substrate 12 side and a second soft magnetic layer 28 on the recording layer 20 side, and the surface roughness of a surface 28A on the recording layer 20 side of the second soft magnetic layer 28 is less than that of the base surface 12A of the substrate 12 and is also less than that of a surface 26A on the recording layer 20 side of the first soft magnetic layer 26. The other configurations are similar to those of a conventional magnetic recording medium, and the descriptions thereof will be omitted as appropriate.

The material for the substrate 12 is glass, and the substrate 12 has a thickness of 0.2 to 2 mm.

The material for the underlayer 14 is Ta (tantalum), Cr (chromium), or a Cr alloy, and the underlayer 14 has a thickness of 30 to 2000 nm.

In the soft magnetic layer 16, both the material for the first soft magnetic layer 26 and that for the second soft magnetic layer 28 are an Fe (iron) alloy or a Co (cobalt) alloy, and the total thickness of the first soft magnetic layer 26 and the second soft magnetic layer 28 is 50 to 300 nm. The first soft magnetic layer 26 is formed to have a thickness larger than that of the second soft magnetic layer 28.

The material for the seed layer 18 is Cr, a non-magnetic Co—Cr (cobalt-chromium) alloy, MgO (magnesium oxide), Ti (titanium), or the like, and the seed layer 18 has a thickness of 3 to 30 nm.

The material for the recording layer 20 is a CO (cobalt) alloy, and the recording layer 20 has a thickness of 5 to 30 nm.

The material for the protective layer 22 is diamond-like carbon, and the protective layer 22 has a thickness of 1 to 5 nm. In the present application, the term “diamond-like carbon (herein after referred to as DLC)” shall refer to a material composed of carbon as an essential ingredient, having an amorphous structure, and having a hardness of about 200 to 8000 kgf/mm² determined by Vickers hardness measurements.

The material for the lubricating layer 24 is PFPE (perfluoropolyether), and the lubricating layer 24 has a thickness of 1 to 2 nm.

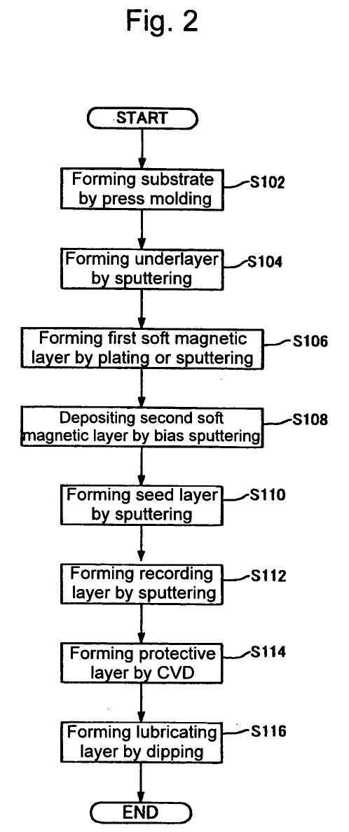

A method for manufacturing the magnetic recording medium 10 will next be described with reference to the flowchart shown in FIG. 2.

First, the substrate 12 is formed by molding (S102). Specifically, glass is heated to a molten state and molded into a plate-like shape by means of press molding. In this manner, the substrate 12 having an arithmetical mean deviation of the surface of the base surface 12A of approximately 10 to 20 nm is obtained as shown in FIG. 3.

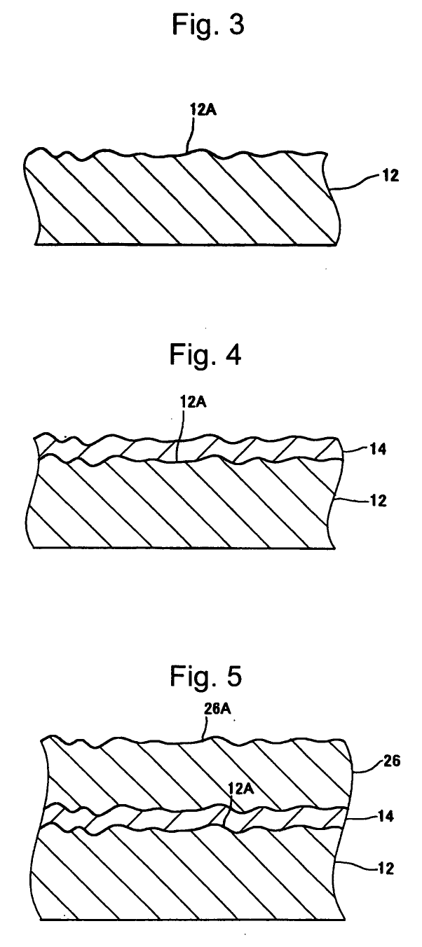

Subsequently, as shown in FIG. 4, the underlayer 14 is formed on the base surface 12A of the substrate 12 by means of a sputtering method (S104). The surface of the underlayer 14 is formed into a shape which follows the surface shape of the base surface 12A of the substrate 12.

Subsequently, as shown in FIG. 5, the first soft magnetic layer 26 is formed on the underlayer 14 by means of a sputtering method or a plating method (S106). The surface 26A of the first soft magnetic layer 26 is formed into a shape which follows the surface shape of the underlayer 14.

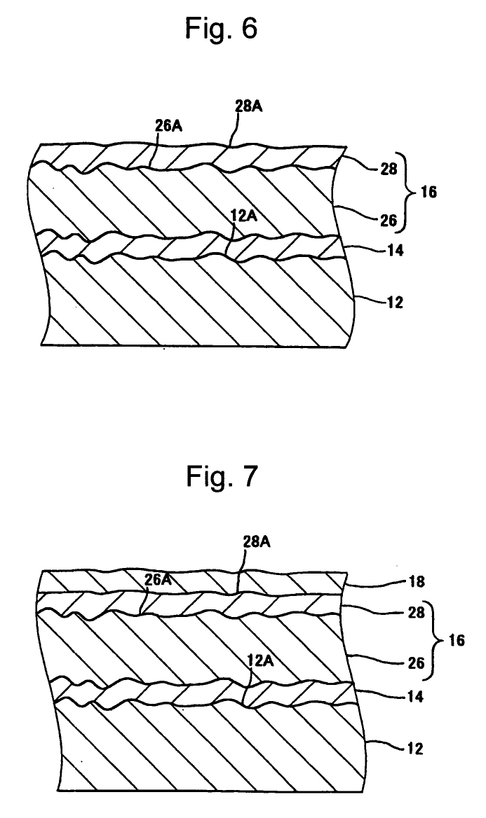

Subsequently, as shown in FIG. 6, the second soft magnetic layer 28 is formed on the first soft magnetic layer 26 by means of a bias sputtering method (S108). In this process, a deposition action of sputtering and an etching action etching part of the existing deposited second soft magnetic layer 28 by sputtering gas energized by bias power are simultaneously taking place, and the deposition progresses as the deposition action outpaces the etching action. The deposition action by sputtering tends to lead the second soft magnetic layer 28 to be deposited to follow the shape of the surface 26A of the first soft magnetic layer 26. However, the etching action tends to lead the projected portions of the deposit to be selectively removed at a faster rate than the other portions. Thus, the second soft magnetic layer 28 is deposited with a surface having a smoothed concavo-convex shape through the etching action. In this manner, the arithmetical mean deviation of the surface of the surface 28A of the second soft magnetic layer 28 becomes about 0.5 to 2 nm. This is less than the surface roughness of the base surface 12A of the substrate 12 and also less than the surface roughness of the surface 26A on the recording layer 20 side of the first soft magnetic layer 26.

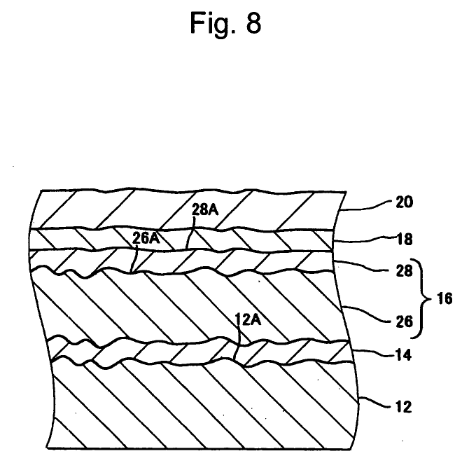

Subsequently, as shown in FIG. 7, the seed layer 18 is formed on the surface 28A of the second soft magnetic layer 28 by means of a sputtering method (S110). The seed layer 18 is formed such that the surface thereof has a flat shape which follows the shape of the surface 28A of the second soft magnetic layer 28. Further, as shown in FIG. 8, the recording layer 20 is formed on the seed layer 18 by means of a sputtering method (S112). The seed layer 18 and the recording layer 20 are formed such that the surfaces thereof have a flat shape which follows the shape of the surface 28A of the second soft magnetic layer 28.

Subsequently, the protective layer 22 is formed on the recording layer 20 by means of a CVD (Chemical Vapor Deposition) method (S114), and the lubricating layer 24 is formed on the protective layer 22 by means of a dipping method (S116). In this manner, the magnetic recording medium 10 shown in FIG. 1 is completed. The protective layer 22 and the lubricating layer 24 are also formed such that the surfaces thereof have a flat shape which follows the shape of the surface 28A of the second soft magnetic layer 28.

As described above, in the magnetic recording medium 10 according to the present exemplary embodiment, conventional substrate polishing is not employed, and the soft magnetic layer 16 has a double-layer structure in which the second soft magnetic layer 28 is deposited on the first soft magnetic layer 26 by means of a bias sputtering method. This suppresses the surface roughnesses of the recording layer 42, the protective layer 22, and the lubricating layer 24, thereby improving production efficiency and reducing cost.

In particular, since the surface roughness of the soft magnetic layer 16 having a larger thickness than the other layers and disposed in a position closer to the surface of the magnetic recording medium 10 is suppressed, the effect of lowering the surface roughness of the magnetic recording medium is enhanced.

In addition, the flat second soft magnetic layer 28 is formed by means of a bias sputtering method. However, in order to flatten the recording layer 20 and to form the recording layer 20, a deposition technique applying bias power and having an etching action is not employed. Thus, the deterioration of the recording layer 20 can be prevented.

Although the bias sputtering method employed for forming the second soft magnetic layer 28 has a flattening effect, the deposition rate is slowed by the etching action. Since the first soft magnetic layer 26 is formed by a sputtering method or a plating method having a deposition rate faster than that of the bias sputtering method, a high production efficiency is achieved.

In the first exemplary embodiment, although the second soft magnetic layer 28 is formed by means of a bias sputtering method, the present invention is not limited thereto. No particular limitation is imposed on the deposition technique, so long as a soft magnetic material can be deposited over the surface of a substrate while bias power is applied in a direction of the substrate. Other deposition technique such as CVD (Chemical Vapor Deposition) with applied bias power or IBD (Ion Beam Deposition) with applied bias power may be employed to form the second soft magnetic layer 28.

A second exemplary embodiment of the present invention will next be described.

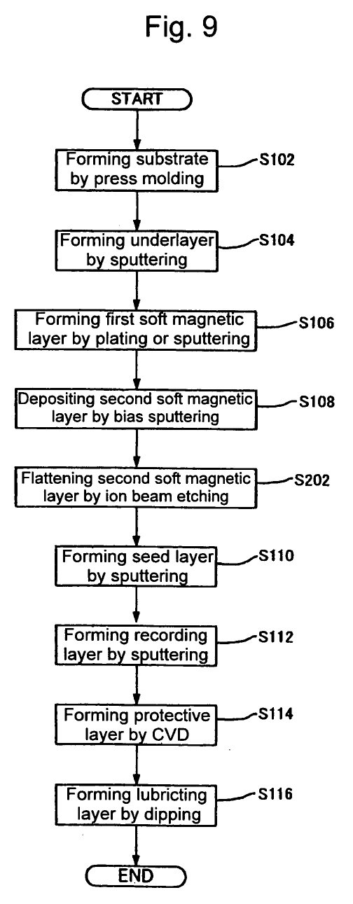

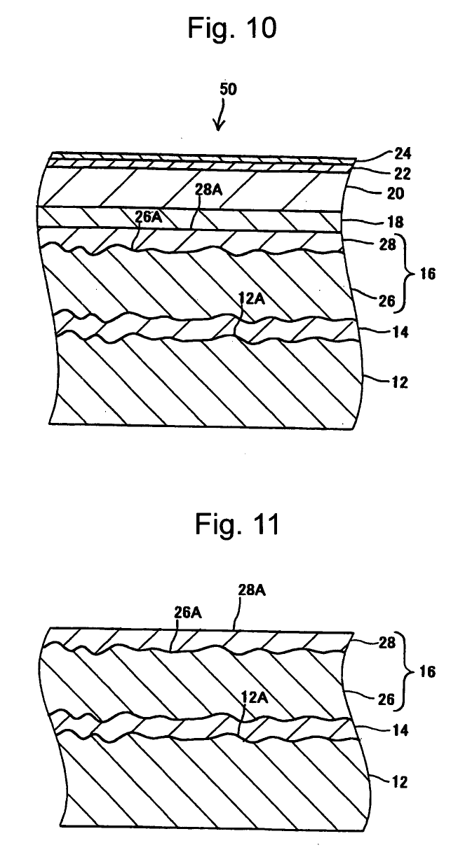

As shown the flowchart of FIG. 9, the second exemplary embodiment is characterized in that a second soft magnetic layer flattening step (S202) of further flattening the surface 28A of the second soft magnetic layer 28 through processing by means of ion beam etching is provided between the second soft magnetic layer deposition step (S108) and the recording layer forming step (S110) in the first exemplary embodiment to thereby obtain a magnetic recording medium 50 shown in FIG. 10 and having a surface roughness less than that of the magnetic recording medium 10 according to the first exemplary embodiment. Since the other configurations are similar to those of the first exemplary embodiment, the same numerals as those employed in FIGS. 1 to 8 are employed and the descriptions thereof will be omitted as appropriate.

First, the underlayer 14 and the first soft magnetic layer 26 are formed over the base surface 12A of the substrate 12 as in the first exemplary embodiment, and then the second soft magnetic layer 28 is deposited by means of a bias sputtering method (see FIG. 6). The second soft magnetic layer 28 is formed such that the surface roughness of the surface 28A is less than that of the base surface 12A of the substrate 12 and also less than that of the surface 26A on the recording layer 20 side of the first soft recording layer 26.

Subsequently, an ion beam such as Ar (argon) is applied from an oblique direction with respect to the surface 28A of the deposited second soft magnetic layer 28 (see FIG. 6) to remove and flatten the surface 28 of the second soft magnetic layer 28. In this case, the incident angle of the ion beam preferably falls within the range of −10 to 15°. The term “incident angle” shall refer to an incident angle with respect to the surface 28A of the second soft magnetic layer 28 and be employed as an angle formed by the surface of an object to be processed and the central axis of the ion beam. For example, if the central axis of the ion beam is parallel to the surface 28A of the second soft magnetic layer 28, the incident angle is 0°.

Since ion beam etching tends to selectively remove a projected portion on the surface at a faster rate than the other portions, the surface 28A of the second soft magnetic layer 28 is further flattened to have an arithmetical mean deviation of the surface Ra of approximately 0.1 to 1 nm, as shown in FIG. 11.

The seed layer 18 (S110), the recording layer 20 (S112), the protective layer 22 (S114), and the lubricating layer 24 (S116) are formed over the surface 28A of the second soft magnetic layer 28 as in the first exemplary embodiment to thereby complete the magnetic recording medium 50 shown in FIG. 10.

As described above, since the surface 28A of the second soft magnetic layer 28 deposited by means of a bias sputtering method is further flattened by means of an ion beam etching method, the surface roughness of the magnetic recording medium 50 can be suppressed to be less as compared with the surface roughness of the magnetic recording medium 10 according to the first exemplary embodiment.

In the first and second exemplary embodiments, the soft magnetic layer 16 has a double-layer structure in which the second soft magnetic layer 28 is formed on the first soft magnetic layer 26, but the present invention is not limited thereto. The soft magnetic layer 16 may have a structure composed of three or more layers.

Also, in the second exemplary embodiment the surface 28A of the second soft magnetic layer 28 is flattened by means of an ion beam etching method, but the present invention is not limited thereto. The surface 28A of the second soft magnetic layer 28 may be flattened by means of other dry etching technique such as reactive ion etching or reactive ion beam etching.

A third exemplary embodiment of the present invention will next be described.

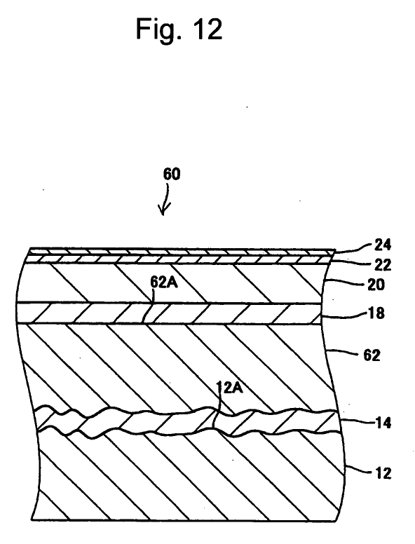

As shown in FIG. 12, a magnetic recording medium 60 according to the third exemplary embodiment is characterized 25 in that the magnetic recording medium 60 comprises a single-layer soft magnetic layer (an intermediate layer) 62, in contrast to the magnetic recording media 10 and 50 according to the first and second exemplary embodiments comprising the soft magnetic layer 16 having a double-layer structure, and the surface roughness of a surface 62A of the single-layer soft magnetic layer 62 is suppressed to be less as compared with the surface roughness of the base surface 12A of the substrate 12.

Since the other configurations are similar to those of the first and second exemplary embodiments, the same numerals as those employed in FIGS. 1 to 11 are employed and the descriptions will be omitted as appropriate.

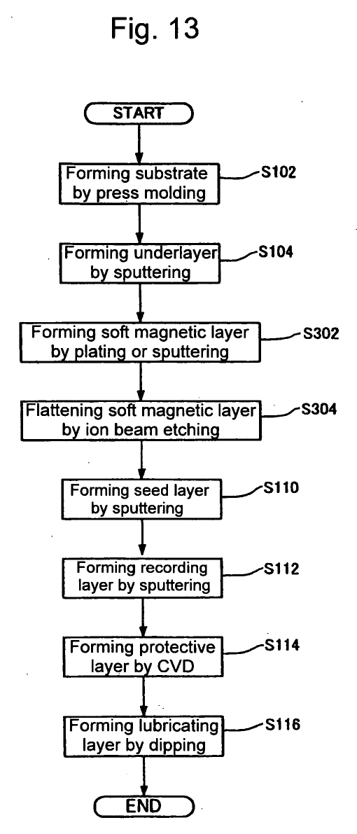

The magnetic recording medium 60 is obtained by means of the manufacturing method shown in the flowchart of FIG. 13. First, the underlayer 14 and the soft magnetic layer 62 are formed over the base surface 12A of the substrate 12 by means of a sputtering method or a plating method (S302, see FIG. 5) as in the first exemplary embodiment.

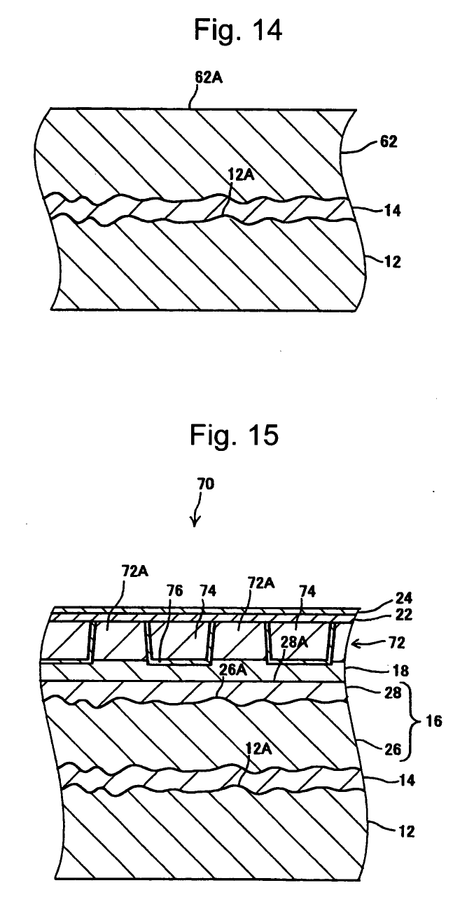

Subsequently, the same procedure as in the second soft magnetic layer flattening step (S202) in the second exemplary embodiment is followed to process the surface 62A of the soft magnetic layer 62 by means of ion beam etching, and the single-layer soft magnetic layer 32 is flattened (S304), as shown in FIG. 14. In this manner, the arithmetical mean deviation of the surface Ra of the surface 62A of the soft magnetic layer 62 becomes approximately 0.1 to 1 nm, which is less than the surface roughness of the base surface 12A of the substrate 12.

The seed layer 18 (S110), the recording layer 20 (S112), the protective layer 22 (S114), and the lubricating layer 24 (S116) are formed over the soft magnetic layer 62 as in the first and second exemplary embodiments to thereby obtain the magnetic recording medium 60 shown in FIG. 12.

Also in the third exemplary embodiment, the soft magnetic layer 32 is flattened by means of a dry process (ion beam etching), and thus a magnetic recording medium can be manufactured with higher efficiency and at lower cost than by a manufacturing method employing a wet process such as a conventional CMP method. In addition, since the soft magnetic layer is formed through depositing only one soft magnetic layer, the production efficiency can be improved also in this respect.

Incidntally, in the third exemplary embodiment, the surface 62A of the single-layer soft magnetic layer 62 is flattened by means of an ion beam etching method, but the present invention is not limited thereto. Other dry etching technique such as reactive ion etching or reactive ion beam etching may be employed to flatten the surface 62A of the single-layer soft magnetic layer 62.

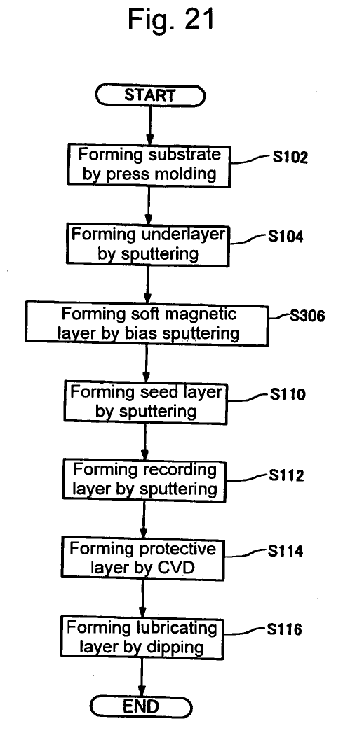

Also, in the third exemplary embodiment, the single-layer soft magnetic layer 62 is formed by means of a sputtering method or a plating method (S302), and then the surface 62A of the soft magnetic layer 62 is flattened by means of ion beam etching (S304). However, the single-layer soft magnetic layer 62 having a flat surface 62A may be formed by means of a bias sputtering method (S306), as shown in the flowchart of FIG. 21. In this case, the single-layer soft magnetic layer 62 may be further flattened by means of dry etching such as ion beam etching.

A manufacturing method may be appropriately selected from among the manufacturing methods of the above-described first to third exemplary embodiments in accordance with required surface roughness and other properties.

A fourth exemplary embodiment of the present invention will next be described.

The fourth exemplary embodiment relates to a magnetic recording medium 70 shown in FIG. 15. In comparison with the magnetic recording medium 50 according to the second exemplary embodiment, the magnetic recording medium 70 comprises a recording layer 72 divided into a large number of recording elements 72A, and is a discrete track type having a non-magnetic material 74 filled in a concave portion between the recording elements 72A. In addition, a separating film 76 is formed on the side and bottom surfaces of the concave portion between the recording elements 72A. Since the other configurations are similar to those of the second exemplary embodiment, the same numerals as those employed in FIGS. 10 and 11 are employed and the descriptions thereof will be omitted.

The material for the non-magnetic material 74 is SiO₂ (silicon dioxide) or the like. Also, the separating film 76 is a hard carbon film made of a material referred to as DLC described above.

This magnetic recording medium 70 can be obtained by: forming, over the substrate 12, the underlayer 14, the soft magnetic layer 16, the seed layer 18, a continuous recording layer (not shown), a plurality of mask layers (not shown), a resist layer (not shown), and other layers in the same manner as in the first and second exemplary embodiments; dividing the continuous recording layer into a large number of the recording elements 72A by means of lithography and dry etching techniques to thereby form the recording layer 72; subsequently forming the separating film 76 by means of a CVD method or other method; filling the concave portion between the recording elements 72A with the non-magnetic material 74 by means of a bias sputtering method; flattening by means of ion beam etching or the like; and forming the protective layer 22 and the lubricating layer 24 in the same manner as in the first and second exemplary embodiments.

The descriptions of the mask layer, the material for the resist layer, the techniques such as lithography and dry etching, and the like, which are employed for dividing and processing the continuous recording layer, will be omitted since these may not be necessary to understand the present invention.

As in the magnetic recording medium 50 according to the second exemplary embodiment, the magnetic recording medium 70 can also be manufactured with high efficiency and at low cost while suppressing the surface roughness to be small.

In the above first to fourth exemplary embodiments, an Fe (iron) alloy or a Co (cobalt) alloy are exemplarily shown as the material for the soft magnetic layer, but the present invention is not limited thereto. No particular limitation is imposed on the material for the soft magnetic layer, so long as the soft magnetic material is suitable for a deposition technique in which bias power is applied and for processing through dry etching.

Further, in the above first to fourth exemplary embodiments, the magnetic recording media 10, 50, 60, and 70 have the base surface 12A on one side of the substrate 12 and have the recording layer and other layers formed on one side, but the present invention is not limited thereto. Both sides of the substrate may serve as the base surface, and the first soft magnetic layer may be formed on both surfaces of the substrate by means of a plating method or a sputtering method. Subsequently, the second soft magnetic layer may be formed by means of a bias sputtering method or other method to form the recording layer and other layers. In this manner, a magnetic recording medium having low surface roughness on both surfaces may be manufactured with high efficiency and at low cost. The surface of the second magnetic layer may be further flattened by means of dry etching such as ion beam etching.

Alternatively, the soft magnetic layer may be formed on both surfaces of the substrate and may be flattened by means of dry etching such as ion beam etching to form the recording layer and other layers over the soft magnetic layer. Alternatively, the single-layer soft magnetic layer may be formed over one base surface of the substrate and flattened by means of dry etching, and the double-layer soft magnetic layer may be formed over the other base surface.

Further, the above first to fourth exemplary embodiments represent part of application examples of the present invention. According to the present invention, other magnetic recording media of various configurations having a soft magnetic layer can also be manufactured with high efficiency at low cost while suppressing the surface roughness.

For example, in the above first to fourth exemplary embodiments, the material for the substrate 12 is glass, but the present invention is not limited thereto. A non-magnetic material such as Al₂O₃ (alumina), Si (silicon), SiO₂ (silicon dioxide), glassy carbon, resin, or the like may be employed as the material for the substrate.

Further, in the above first to fourth exemplary embodiments, the material for the recording layer 20 (72) is a CoCr alloy, but the present invention is not limited thereto. The present invention is applicable to the manufacturing of a magnetic recording medium comprising a recording layer formed of other material such as other alloys containing iron group elements (Co, Fe (iron), and Ni) or a laminate thereof.

Further, in the above first to fourth exemplary embodiments, the underlayer 14 is formed between the substrate 12 and the soft magnetic layer 16 (62), but the present invention is not limited thereto. The layer configuration provided between the substrate 12 and the soft magnetic layer 16 (62) may be appropriately changed in accordance with the type of a magnetic recording medium. For example, a plurality of layers may be formed between the substrate 12 and the soft magnetic layer 16 (62). Also, the soft magnetic layer may be formed directly on the substrate.

Further, in the above first to fourth exemplary embodiments, the seed layer 18 is formed between the soft magnetic layer 16 (62) and the recording layer 20 (72), but the present invention is not limited thereto. The layer configuration provided between the soft magnetic layer 16 (62) and the recording layer 20 (72) may be appropriately changed in accordance with the type of a magnetic recording medium. For example, a plurality of layers may be formed between the soft magnetic layer 16 (62) and the recording layer 20 (72). Also, the recording layer 20 (72) may be formed directly on the soft magnetic layer 16 (62) serving as an intermediate layer.

Further, in the above first to fourth exemplary embodiments, the magnetic recording medium 10 (50, 60, or 70) having low surface roughness is obtained by lowering the surface roughness of the surface 28A (62A) of the soft magnetic layer 16 (62) to less than the surface roughness of the base surface 12A of the substrate 12. However, a magnetic recording medium having low surface roughness may be implemented by, for example, lowering the surface roughness of other intermediate layer, such as the underlayer 14 or the seed layer 18, provided between the substrate 12 and the recording layer 20 (72) to less than the surface roughness of the base surface 12A of the substrate 12. In this case, a magnetic recording medium having low surface roughness can also be manufactured with high efficiency at low cost, and the deterioration of the recording layer can be prevented. It is conceivable that the effect of lowering the surface roughness of the magnetic recording medium increases as the position of the intermediate layer having a surface roughness less than the surface roughness of the base surface 12A of the substrate 12 approaches the surface of the magnetic recording medium. Thus, preferably, a layer, such as the soft magnetic layer 16 or a seed layer 18, provided in a position close to the recording layer serves as the intermediate layer having a surface roughness less than the surface roughness of the base surface 12A of the substrate 12. The soft magnetic layer is significantly thicker than the other layers. Therefore, if the intermediate layer is provided in the substrate side of the soft magnetic layer, the effect of lowering the surface roughness of the magnetic recording medium is lowered. Thus, desirably, a layer which is located closer to the surface of the magnetic recording medium than the soft magnetic layer is located, or the soft magnetic layer itself serves as the intermediate layer having a surface roughness less than the surface roughness of the base surface 12A of the substrate 12. In order to enhance the effect of lowering the surface roughness of the magnetic recording medium, the intermediate layer having a surface roughness less than the surface roughness of the base surface 12A of the substrate 12 is more preferably a layer provided in a position being in contact with the recording layer.

Moreover, in the above fourth exemplary embodiment, the magnetic recording medium 70 is of a perpendicular recording type and also a discrete track type in which the recording elements 72A are arranged in the radial direction of a track at fine intervals, but the present invention is not limited thereto. Of course, the present invention is applicable to the manufacturing of a magnetic disk in which the recording elements are arranged side by side in the circumferential direction (the sector direction) of the track at fine intervals, a magnetic disk in which the recording elements are arranged side by side in both the radial and circumferential directions of the track at fine intervals, and a magnetic disk in which the recording elements have a spiral shape. Further, the present invention is applicable to a magneto-optical disc such as MO and a recording disk of a heat assisted type which utilizes magnetism in combination with heat.

Moreover, in the above first to fourth exemplary embodiments, the magnetic recording medium 10 (50, 60, or 70) is of a perpendicular recording type. However, the present invention is applicable to a recording disk of a longitudinal recording type.

### WORKING EXAMPLE 1

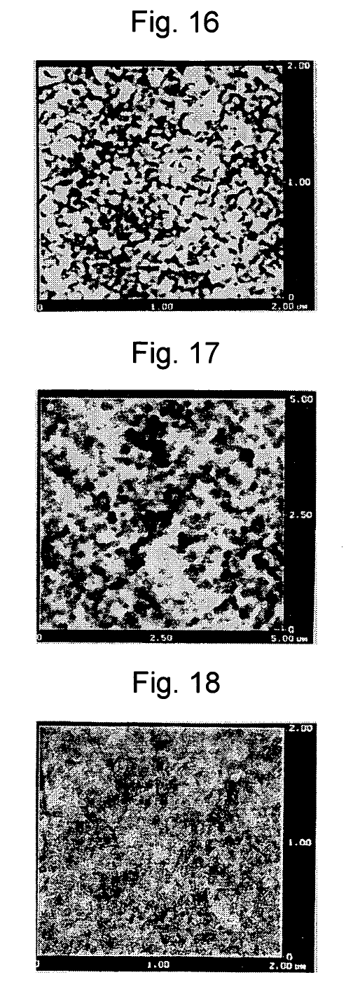

A magnetic recording medium 10 was produced as in the above first exemplary embodiment, and the surface roughness of the second soft magnetic layer 28 was measured during the production process. Specifically, the substrate 12 made of glass and having a diameter of approximately 21.6 mm, a thickness of approximately 0.38 mm, and a center hole having an inner diameter of approximately 6.0 mm was formed by means of press molding. An image of the base surface 12A of the substrate 12 was taken by an AFM (Atomic Force Microscope), and the image shown in FIG. 16 was obtained. The arithmetical mean deviation of the surface Ra of the base surface 12A of the substrate 12 was determined based on FIG. 16 and was found to be approximately 12.37 nm.

Subsequently, the underlayer 14 formed of Ta was deposited to a thickness of approximately 30 nm on the base surface 12A of the substrate 12 by means of a sputtering method. Further, an electrode film was deposited through employing Cr as the material therefor to a thickness of about 20 nm on the underlayer 14 by means of a sputtering method, and then the first soft magnetic layer 26 was deposited by means of an electrolytic plating method. Specifically, the first soft magnetic layer 26 was deposited to a thickness of approximately 150 nm at a temperature of 50° C. by use of a mixture of nickel sulfamate and iron sulfamate having a pH of 4. An image of the surface 26A of the first soft magnetic layer 26 was taken by an AFM (Atomic Force Microscope), and the image shown in FIG. 17 was obtained. The arithmetical mean deviation of the surface Ra of the surface 26A of the first soft magnetic layer 26 was determined based on FIG. 17 and was found to be about 7.64 nm. That is, the first soft magnetic layer 26 had a surface roughness less than that of the base surface 12A of the substrate 12.

Subsequently, the second soft magnetic layer 28 was deposited to a thickness of approximately 100 nm on the first soft magnetic layer 26 by means of a bias sputtering method. Ar gas was employed in the bias sputtering, and the bias sputtering conditions were set as follows:

Ar flow rate: 100 sccm,

Gas pressure: 1.0 Pa,

Applied electric power: 500 W, and

Substrate bias voltage: 250 W.

An image of the surface of the second soft magnetic layer 28 was taken by an AFM (Atomic Force Microscope), and the arithmetical mean deviation of the surface Ra of the second soft magnetic layer 28 was determined based on the obtained image (not shown) and was found to be approximately 0.72 nm. That is, the surface roughness of the second soft magnetic layer 28 was confirmed to be significantly lowered as compared with the surface roughness of the base surface 12A of the substrate 12.

### WORKING EXAMPLE 2

The magnetic recording medium 50 was produced as in the above second exemplary embodiment, and the surface roughness of the second soft magnetic layer 28 was measured during the production process. Specifically, the first soft magnetic layer 26 and the second soft magnetic layer 28 were deposited through the steps as in Working Example 1 described above, and the surface of the second soft magnetic layer 28 was flattened by means of ion beam etching. Ar gas was employed in the ion beam etching, and the processing was performed while the substrate 12 was rotated. The ion beam etching conditions were set as follows:

Ar gas flow rate: 11 sccm,

Gas pressure: 0.05 Pa,

Beam voltage: 500 V,

Beam current: 500 mA,

Suppressor voltage: 400 W, and

Ion beam incident angle: 3°.

An image of the surface of the second soft magnetic layer 28 was taken by an AFM (Atomic Force Microscope), and the image shown in FIG. 18 was obtained. The arithmetical mean deviation of the surface Ra of the second soft magnetic layer 28 was determined based on FIG. 18 and was found to be approximately 0.46 nm. That is, the surface roughness of the second soft magnetic layer 28 was confirmed to be further lowered than in Working Example 1.

### WORKING EXAMPLE 3

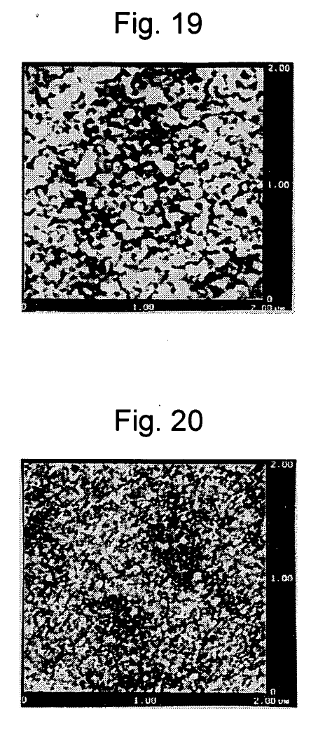

In contrast to Working Example 1, the first soft magnetic layer 26 was deposited to a thickness of approximately 150 nm by means of a sputtering method. In this case, the electrode film was not deposited on the underlayer 14. The other conditions were the same as in Working Example 1 described above. An image of the surface 26A of the first soft magnetic layer 26 was taken by an AFM (Atomic Force Microscope), and the image shown in FIG. 19 was obtained. The arithmetical mean deviation of the surface Ra of the surface 26A of the first soft magnetic layer 26 was determined based on FIG. 19 and was found to be approximately 14.12 nm. That is, the first soft magnetic layer 26 had a surface roughness larger than that of the base surface 12A of the substrate 12.

Subsequently, the second soft magnetic layer 28 was deposited to a thickness of approximately 100 nm on the first soft magnetic layer 26 by means of a bias sputtering method as in Working Example 1. An image of the surface of the second soft magnetic layer 28 was taken by an AFM (Atomic Force Microscope), and the arithmetical mean deviation of the surface Ra of the second soft magnetic layer 28 was determined based on the obtained image (not shown) and was found to be approximately 0.88 nm. That is, the surface roughness of the second soft magnetic layer 28 was confirmed to be significantly lowered as compared with the surface roughness of the base surface 12A of the substrate 12.

### WORKING EXAMPLE 4

In contrast to Working Example 2 described above, the first soft magnetic layer 26 and the second soft magnetic layer 28 were deposited by means of the same steps as in Working Example 3 described above (instead of the steps in Working Example 1 described above). The surface of the second soft magnetic layer 28 was then flattened by means of ion beam etching to produce the magnetic recording medium 50, and the surface roughness of the second soft magnetic layer 28 was measured during the production process. The other conditions were the same as in Working Example 2 described above.

An image of the surface of the second soft magnetic layer 28 was taken by an AFM (Atomic Force Microscope), and the arithmetical mean deviation of the surface Ra of the second soft magnetic layer 28 was determined based on the obtained image (not shown) and was found to be approximately 0.55 nm. That is, the surface roughness of the second soft magnetic layer 28 was confirmed to be further lowered than in Working Example 3.

### WORKING EXAMPLE 5

The magnetic recording medium 60 having the single-layer soft magnetic layer 62 was produced as in the above third exemplary embodiment, and the surface roughness of the soft magnetic layer 62 was measured during the production process. Specifically, the same steps as in the above described Working Example 1 up to the first soft magnetic layer 26 was formed were employed as the steps up to the soft magnetic layer 62 was deposited, and the surface of the deposited soft magnetic layer 62 was flattened by means of ion beam etching.

An image of the surface of the soft magnetic layer 62 was taken by an AFM (Atomic Force Microscope), and the arithmetical mean deviation of the surface Ra of the second soft magnetic layer 28 was determined based on the obtained image (not shown) and was found to be about 0.72 nm. That is, the surface roughness of the soft magnetic layer 62 was confirmed to be significantly lowered as compared with the surface roughness of the base surface 12A of the substrate 12.

### WORKING EXAMPLE 6

In contrast to Working Example 5 described above, the same steps as in the above described Working Example 3 (in stead of Working Example 1 described above) up to the first soft magnetic layer 26 was formed were employed as the steps up to the soft magnetic layer 62 was deposited. The surface of the deposited soft magnetic layer 62 was then flattened by means of ion beam etching to produce the magnetic recording medium 60, and the surface roughness of the soft magnetic layer 62 was measured during the production process. The other conditions were the same as in Working Example 5 described above.

An image of the surface of the soft magnetic layer 62 was taken by an AFM (Atomic Force Microscope), and the image shown in FIG. 20 was obtained. The arithmetical mean deviation of the surface Ra of the second soft magnetic layer 28 was determined based on FIG. 20 and was found to be approximately 0.76 nm. That is, the surface roughness of the soft magnetic layer 62 was confirmed to be significantly lowered as compared with the surface roughness of the base surface 12A of the substrate 12.

The measurement results of Working Examples 1 to 6 described above are shown and compared in Table 1.

TABLE 1

| | | Working | Working | Working | Working | Working | Working |
|---|---|---|---|---|---|---|---|
| | | Example 1 | Example 2 | Example 3 | Example 4 | Example 5 | Example 6 |
| Substrate | Processing | Press molding | | | | | |
| | method | | | | | | |
| | Surface | 12.37 | | | | | |
| | roughness | | | | | | |
| | Ra(nm) | | | | | | |
| First soft | Processing | Plating | | Sputtering | | Plating + | Sputtering + |
| magnetic | method | | | | | Ion beam | Ion beam |
| layer | | | | | | etching | etching |
| (Soft | Surface | 7.64 | | 14.12 | | 0.63 | 0.76 |
| magnetic | roughness | | | | | | |
| layer) | Ra(nm) | | | | | | |
| Second | Processing | Bias | Bias | Bias | Bias | — | — |
| soft | method | sputtering | sputtering + | sputtering | sputtering + | | |
| magnetic | | | Ion beam | | Ion beam | | |
| layer | | | etching | | etching | | |
| | Surface | 0.72 | 0.46 | 0.88 | 0.55 | — | — |
| | roughness | | | | | | |
| | Ra(nm) | | | | | | |

As shown in Table 1, in each of Working Examples 1 to 6, the arithmetical mean deviation of the surface of the second soft magnetic layer 28 (the soft magnetic layer 62) is suppressed to 1 nm or less. Thus, the flatness is found to be sufficient for obtaining favorable head flying.

In addition, the surface roughness of the second soft magnetic layer 28 can largely be lowered by forming the soft magnetic layer into a double-layer structure, depositing the second soft magnetic layer 28 by means of a bias sputtering method, and flattening by means of ion beam etching.

Further, even if the soft magnetic layer has a single-layer structure, through flattening the surface of the soft magnetic layer by means of ion beam etching, the surface roughness can be lowered to less than the surface roughness of the soft magnetic layer having a double-layer structure before flattening by means of ion beam etching.

Further, through employing a plating method as a technique for depositing the first soft magnetic layer 26 (the soft magnetic layer 62), the surface roughness of the first soft magnetic layer 26 (the soft magnetic layer 62) after the deposition can be lowered to less than in the case where a sputtering method is employed. In this manner, the surface roughness of the second soft magnetic layer 28 (the soft magnetic layer 62) can be lowered.

### INDUSTRIAL APPLICABILITY

The present invention can be utilized for manufacturing a magnetic recording medium having low surface roughness with high efficiency at low cost. Advantage of Invention

According to the present invention, a magnetic recording medium having low surface roughness can be manufactured even if the surface roughness of the base surface of a substrate is large. Therefore, the production efficiency of the magnetic recording medium can be improved, and the cost of the magnetic recording medium can be reduced.

1. A magnetic recording medium having a soft magnetic layer and a recording layer formed in this order over a base surface of a substrate having at least one surface serving as the base surface,
wherein an intermediate layer is provided between the substrate and the recording layer, and a surface roughness of the surface on the recording layer side of the intermediate layer is less than a surface roughness of the base surface of the substrate.

2. The magnetic recording medium according to claim 1, wherein the soft magnetic layer serves also as the intermediate layer.

3. The magnetic recording medium according to claim 2, wherein: the soft magnetic layer has a laminate structure of a first soft magnetic layer on the side of the substrate and a second soft magnetic layer on the side of the recording layer; and the surface roughness of the surface on the recording layer side of the second soft magnetic layer is less than the surface roughness of the base surface of the substrate and is less than the surface roughness of the surface on the recording layer side of the first soft magnetic layer.

4. A magnetic recording medium having a recording layer formed over a base surface of a substrate having at least one surface serving as the base surface,
wherein an intermediate layer is provided between the substrate and the recording layer so as to be in contact with the recording layer, and a surface roughness of the surface on the recording layer side of the intermediate layer is less than a surface roughness of the base surface of the substrate.

5. The magnetic recording medium according to claim 1, wherein an arithmetical mean deviation of the surface on the recording layer side of the intermediate layer is 1 nm or less.

6. A method for manufacturing a magnetic recording medium having a soft magnetic layer and a recording layer formed in this order over a base surface of a substrate having at least one surface serving as the base surface,
the method comprising: an intermediate layer forming step of forming an intermediate layer over the base surface of the substrate while applying a bias power in a direction of the substrate such that a surface roughness of the intermediate layer is less than a surface roughness of the base surface of the substrate; and a recording layer forming step of forming the recording layer over the intermediate layer.

7. A method for manufacturing a magnetic recording medium having a soft magnetic layer and a recording layer formed in this order over a base surface of a substrate having at least one surface serving as the base surface,
the method comprising: an intermediate layer forming step of forming an intermediate layer over the base surface of the substrate; an intermediate layer flattening step of flattening the surface of the intermediate layer by processing by means of dry etching such that a surface roughness of the intermediate layer is less than a surface roughness of the base surface of the substrate; and a recording layer forming step of forming the recording layer over the intermediate layer.

8. The method for manufacturing a magnetic recording medium according to claim 6, wherein the soft magnetic layer is formed as the intermediate layer in the intermediate layer forming step.

9. A method for manufacturing a magnetic recording medium having a recording layer formed over a base surface of a substrate having at least one surface serving as the base surface,
the method comprising: an intermediate layer forming step of forming an intermediate layer over the base surface of the substrate while applying a bias power in a direction of the substrate such that a surface roughness of the intermediate layer is less than a surface roughness of the base surface of the substrate; and a recording layer forming step of forming the recording layer on the intermediate layer so as to be in contact with the intermediate layer.

10. The method for manufacturing a magnetic recording medium according to claim 6, wherein an intermediate layer flattening step of flattening the surface of the intermediate layer by means of dry etching is provided between the intermediate layer forming step and the recording layer forming step.

11. A method for manufacturing a magnetic recording medium having a recording layer formed over a base surface of a substrate having at least one surface serving as the base surface,
the method comprising: an intermediate layer forming step of forming an intermediate layer over the base surface of the substrate; an intermediate layer flattening step of flattening the surface of the intermediate layer by processing by means of dry etching such that a surface roughness thereof is less than a surface roughness of the base surface of the substrate; and a recording layer forming step of forming the recording layer on the intermediate layer so as to be in contact with the intermediate layer.

12. A method for manufacturing a magnetic recording medium according to claim 6, wherein the surface of the intermediate layer is finished such that an arithmetical mean deviation of the surface is 1 nm or less.

13. A method for manufacturing a magnetic recording medium according to claim 8, wherein the surface of the intermediate layer is finished such that an arithmetical mean deviation of the surface is 1 nm or less.

14. A method for manufacturing a magnetic recording medium having a soft magnetic layer and a recording layer formed in this order over a base surface of a substrate having at least one surface serving as the base surface,
the method comprising: a first soft magnetic layer forming step of forming a first soft magnetic layer by depositing a soft magnetic material over the base surface of the substrate by means of either a sputtering method or a plating method; a second soft magnetic layer forming step of forming a second soft magnetic layer having a surface roughness less than a surface roughness of the base surface of the substrate by depositing a soft magnetic material on the first soft magnetic layer while a bias power is applied in a direction of the substrate; and a recording layer forming step of forming the recording layer over the second soft magnetic layer.

15. A method for manufacturing a magnetic recording medium having a soft magnetic layer and a recording layer formed in this order over a base surface of a substrate having at least one surface serving as the base surface,
the method comprising: a first soft magnetic layer forming step of forming a first soft magnetic layer by depositing a soft magnetic material over the base surface of the substrate by means of either a sputtering method or a plating method; a second soft magnetic layer forming step of forming a second soft magnetic layer by depositing a soft magnetic material on the first soft magnetic layer while a bias power is applied in a direction of the substrate; a soft magnetic layer flattening step of flattening the surface of the second soft magnetic layer such that a surface roughness is less than a surface roughness of the base surface of the substrate by processing the surface of the second soft magnetic layer by means of dry etching; and a recording layer forming step of forming the recording layer over the second soft magnetic layer.

16. The method for manufacturing a magnetic recording medium according to claim 14, wherein the surface of the second soft magnetic layer is finished such that an arithmetical mean deviation of the surface is 1 nm or less.

17. The magnetic recording medium according to claim 4, wherein an arithmetical mean deviation of the surface on the recording layer side of the intermediate layer is 1 nm or less.

18. The method for manufacturing a magnetic recording medium according to claim 7, wherein the soft magnetic layer is formed as the intermediate layer in the intermediate layer forming step.

19. The method for manufacturing a magnetic recording medium according to claim 9, wherein an intermediate layer flattening step of flattening the surface of the intermediate layer by means of dry etching is provided between the intermediate layer forming step and the recording layer forming step.

20. The method for manufacturing a magnetic recording medium according to claim 15, wherein the surface of the second soft magnetic layer is finished such that an arithmetical mean deviation of the surface is 1 nm or less.
